(19) United States
(12) Patent Application Publication
(10) Pub. No.: US 2001/0030409 A1
(43) Pub. Date: Oct. 18, 2001

(54) Trailer hitch alignment device

(76) Inventor: William Williams, Riverton, UT (US)

Correspondence Address: David R. McKinney, THORPE NORTH & WESTERN, L.L.P., P.O. Box 1219, Sandy, UT, 84091-1219, US

(21) Appl. No.: 09/853,456

(22) Filed: May 10, 2001

Related U.S. Application Data
(60) Provisional application No. 60/203,006, filed on May 10, 2000.

(51) Int. Cl. B60D 1/36

(52) U.S. Cl. 280/477

(57) ABSTRACT

A trailer hitch alignment device configured to be connected to a drop bar of a drop hitch, the drop bar having a substantially horizontal portion, an upwardly extending portion, and an elbow therebetween, the device comprising a substantially horizontal base plate having an aperture configured to accommodate a stem of a trailer hitch ball, a substantially vertical back plate, fixedly attached to the base plate, having outwardly flared sides and an apex therebetween, and being configured to partially surround the trailer hitch ball, and a drop bar notch, formed in the base plate and the back plate in a region of the apex, and configured to receive a portion of the elbow of the drop bar.

### SPECIFICATION

This application claims priority from U.S. Provisional Patent Application Ser. No. 60/203,006, filed on May 10, 2000.

### BACKGROUND OF THE INVENTION

1. Field of the Invention

The present invention relates generally to trailer hitches. More particularly, the present invention relates to a device for assisting in aligning the tongue of a trailer with a corresponding trailer hitch.

2. Related Art

When towing a trailer or other towed vehicle, it is sometimes desirable for an individual to be able to complete the hitching operation without the need for help. However, without an assistant to provide guidance when backing the towing vehicle toward the towed vehicle, it can be difficult to place the hitch ball of the towing vehicle in proper alignment with the hitch of the towed vehicle so as to allow interconnection of the two. This is a particular problem where the towed vehicle is large and heavy, and the user cannot easily move it's hitch tongue into position. Consequently, to place the hitch ball in precisely the right spot, the user generally must resort to trial and error, backing up, then pulling away, then backing up again to place the hitch ball in the right location. This can be frustrating and time consuming. To simplify the hitching process, devices have been developed which help guide the hitch tongue into the proper position for hitching, even when the towing vehicle does not move into exactly the right spot.

In recent years, with the increasing popularity of four wheel drive and sport utility vehicles, more and more drivers have high ground clearance vehicles. However, the height of a standard trailer has not changed. Consequently, drop hitches, which allow a standard height hitch ball to be attached to the frame of a high ground clearance vehicle, have become more common. Because of their shape and configuration, drop hitches present special challenges for creating trailer hitch alignment devices which will allow easy connection of trailers to high ground clearance vehicles.

### SUMMARY OF THE INVENTION

It has been recognized that it would be advantageous to develop a trailer hitch alignment device which automatically aligns the tongue of a trailer with the ball of a trailer hitch.

It has also been recognized that it would be advantageous to develop a trailer hitch alignment device which can be installed on drop hitches.

The invention provides a trailer hitch alignment device configured to be connected to a drop bar of a drop hitch, the drop bar having a substantially horizontal portion, an upwardly extending portion, and an elbow therebetween. The device includes a substantially horizontal base plate having an aperture configured to accommodate a stem of a trailer hitch ball, a substantially vertical back plate, fixedly attached to the base plate, having outwardly flared sides and an apex therebetween, and being configured to partially surround the trailer hitch ball, and a drop bar notch, formed in the base plate and the back plate in a region of the apex, and configured to receive a portion of the elbow of the drop bar.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a perspective view of a trailer hitch alignment device in accordance with the present invention.

FIG. 2 is a perspective view of the trailer hitch alignment device of FIG. 1 installed upon the drop bar of a drop hitch installed on a vehicle.

FIG. 3 is a top view of the trailer hitch alignment device and drop hitch of FIG. 2 with the tongue of a trailer approaching the hitching position.

FIG. 4A is a partial cross-sectional side view of the trailer hitch alignment device of FIG. 1 taken along line 4-4.

FIG. 4B is a partial cross-sectional side view similar to FIG. 4A, of an alternative device wherein the drop bar notch comprises a bulge formed in a continuous sheet of material.

### DETAILED DESCRIPTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

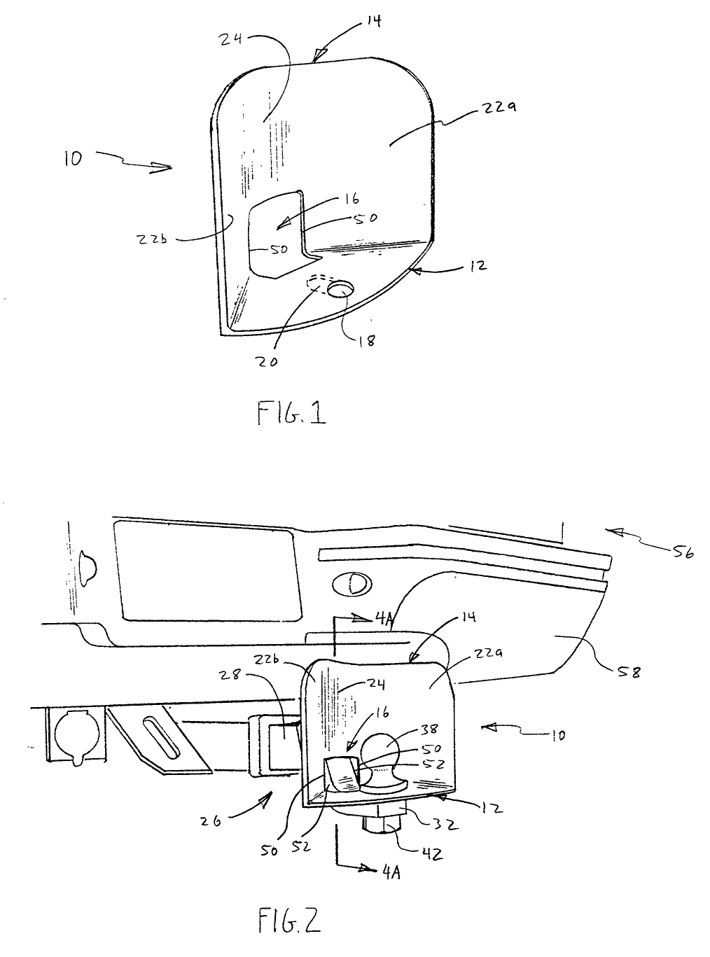

Viewing FIG. 1, a trailer hitch alignment device 10 in accordance with the present invention generally comprises a substantially horizontal base plate 12, a substantially vertical back plate 14, and a drop bar notch 16. The base plate 12 includes an aperture for accommodating the stem of a trailer hitch ball. The aperture may take the form of a hole 18, or may comprise an elongated slot 20 (shown in dashed lines) to allow adjustment of the position of the device.

The vertical back plate 14 is fixedly attached to the base plate 12, either by welding or integral fabrication. The back plate includes outwardly flared sides 22a, b, which extend outward at an angle from an apex 24 therebetween. The apex is preferably a region wherein the back plate is curved about a substantially vertical axis (not shown). The flared sides and apex are configured to partially surround a trailer hitch ball, and allow for clearance and pivoting of a trailer tongue, as discussed in more detail below.

For strength and durability, the device 10 may be formed of metal, and may be painted or finished in any desired manner. The back plate 14 and base plate 12 may be fabricated as separate plates which are welded together, or the entire device may be stamped or pressed from a single piece of sheet metal. Alternatively, the device could be formed of durable plastic materials, fiberglass, or any other material which is suitably strong. It is also preferable that the device be resistant to damage or deterioration due to weather conditions, etc.

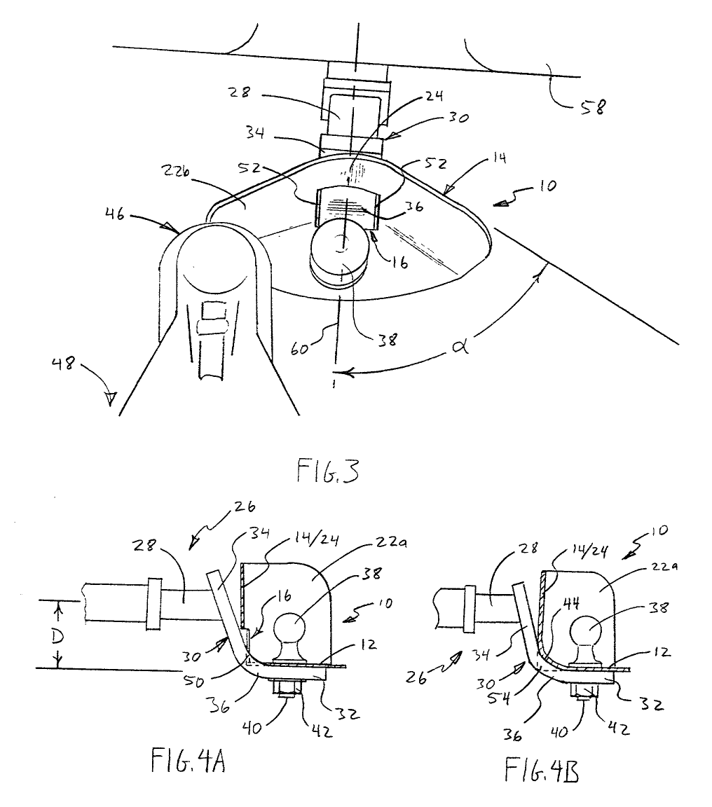

The drop bar notch 16 is formed in the base plate 12 and the back plate 14, in the region of the apex 24. Referring to FIG. 2 and FIG. 4A, the device 10 comprises part of a trailer hitch system which is attachable to a vehicle 56 adjacent the rear bumper 58 or other rear extremity. The drop hitch 26 includes a substantially horizontal hitch stem 28, and a drop bar 30. The drop bar includes a substantially horizontal portion 32, an upwardly extending portion 34, and an elbow 36 therebetween. The upwardly extending portion 34 may be substantially vertical, or may be inclined at an angle as shown in the figures. The elbow 36 typically comprises a curved portion as shown, though it could be formed with an abrupt or sharp angle. The device 10 is affixed to the horizontal portion of the drop bar by the trailer hitch ball 38, which includes a stem 40 that is secured with a nut 42 on the underside of the horizontal portion of the drop bar.

As is visible from FIG. 4A, the drop bar notch 16 is configured to receive a portion of the elbow 36 and/or the upwardly extending portion 34 of the drop bar 30. This configuration advantageously allows the device 10 to be disposed forwardly on the horizontal portion of the drop bar, to provide greater clearance between the back plate 14 and the ball 38. In FIG. 4A the drop bar notch 16 is shown as an aperture extending through the back plate 14 and the base plate 12. The drop bar notch includes vertical sides 50 configured to align with and pass over the sides 52 of the drop bar. This configuration provides stability and easy alignment of the device with the drop hitch. However, depending upon the width of the drop bar, it can also allow slight side-to-side adjustment of the position of the device on the drop bar.

It will be apparent that the notch 16 could also be configured differently. For example, viewing FIG. 4B, the drop bar notch 16 could comprise a bulge or distended portion 44 of the back plate 14 and base plate 12, the bulge being specially sized to conform to the exact size, shape, and curvature of the elbow 36 and upwardly extending portion 34 of the drop bar. This configuration may be particularly suitable for formation through stamping or pressing of the device from a continuous piece of sheet metal. The device would still provide adequate clearance for the tongue of the trailer hitch, the clearance being reduced only by an amount approximately equal to the thickness of the metal. This alternative configuration also provides vertical sides 54 (shown in dashed lines) which extend over the sides 52 of the drop bar, and provide the benefits mentioned above.

Viewing FIG. 3, the outwardly flared sides 22 of the back plate 14 provide guiding surfaces which help align the tongue 46 of a trailer 48 with the ball 38 of the trailer hitch. As the tongue moves close to the ball, if it is misaligned slightly, as shown in FIG. 3, it strikes the flared sides 22 and is deflected toward the apex 24. The flared sides may be configured with an angle α ranging from about 20° to about 80° relative to the centerline 60 of the drop hitch stem 28 (which presumably coincides with the centerline of the vehicle). As shown in FIG. 3, a preferred angle α is about 50°.

Returning to FIG. 4A, drop hitches provide a drop distance D. With the increased popularity of high ground clearance vehicles, drop hitches with relatively large drops are more and more common, such as 6, 8, 10 inches, or more. Unlike many prior art devices, the drop bar notch 16 of the present invention advantageously allows the device to be used with drop hitches having very large drops. For example, some other devices cannot be used with drops hitches at all, and others cannot be used with drops of more than about 2 inches and still provide adequate clearance around the hitch ball. However, the present invention can be used with any drop size, and still provide the benefits of automatic hitch alignment and clearance of the hitch tongue. It will also be apparent that the device may be mounted directly to a bumper, in addition to the drop hitch installation illustrated herein.

The invention thus makes backing up to a trailer or other towed vehicle simpler. The device allows one person to easily hitch a towed vehicle, and makes a hitching maneuver more likely to be a one-try operation, rather than trial and error. The device also protects the vehicle bumper from dents during hitching operations. The device simply bolts onto a bumper or receiver under the hitch ball. When a user backs up to a trailer tongue or comparable structure to attempt to hitch to it, if the hitch is off by only a few inches, the user simply continues to gently back up and the flared sides of the device will automatically guide the tongue into alignment over the ball.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been shown in the drawings and fully described above with particularity and detail in connection with what is presently deemed to be the most practical and preferred embodiment(s) of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A trailer hitch alignment device configured to be connected to a drop bar of a drop hitch, the drop bar having a substantially horizontal portion, an upwardly extending portion, and an elbow therebetween, the device comprising:
a substantially horizontal base plate having an aperture configured to accommodate a stem of a trailer hitch ball;
a substantially vertical back plate, fixedly attached to the base plate, having outwardly flared sides and an apex therebetween, and being configured to partially surround the trailer hitch ball in order to guide a tongue of a towed vehicle toward the hitch ball; and
a drop bar notch, formed in both the base plate and the back plate in a region of the apex, and configured to receive a portion of the elbow of the drop bar.

2. The device according to claim 1, wherein the drop bar notch includes an aperture extending through the back plate and the base plate.

3. The device according to claim 1, wherein the drop bar notch includes vertical sides configured to align with the sides of the drop bar.

4. The device according to claim 1, wherein the device is configured to attach to a drop hitch having a drop of more than 2 inches.

5. The device according to claim 1, further comprising a stem of a trailer hitch ball, extending through the aperture and bolting to a drop bar, thereby coupling the base plate to the drop bar.

6. The device according to claim 1, wherein the aperture configured to accommodate a stem of a trailer hitch ball includes an elongated slot, whereby the position of the device upon the drop bar may be adjusted.

7. The device according to claim 1, wherein the outwardly flared sides of the back plate are flared at an angle of from about 20° to about 80° relative to a centerline of the drop bar.

8. The device according to claim 7, wherein the outwardly flared sides of the back plate are flared at an angle of about 50°.

9. The device according to claim 1, wherein the device is fabricated of materials selected from the group consisting of welded metal plates, stamped or pressed sheet metal, plastic, and fiberglass.

10. The device according to claim 1, wherein the device comprises a continuous piece of sheet metal, and the drop bar notch comprises a bulge formed in the back plate and the base plate, the bulge being configured to conform to the curvature of at least one of the elbow and the upwardly extending portion of a drop bar.

11. A trailer hitch system, comprising:
a drop trailer hitch, configured to be attached to a vehicle, having a drop bar with a substantially horizontal portion, an upwardly extending portion, and an elbow therebetween;
a trailer hitch ball, having a stem, coupled to the substantially horizontal portion of the drop bar;
a trailer hitch alignment device, coupled to the drop bar and partially surrounding the trailer hitch ball, said trailer hitch alignment device including:
(1) a substantially horizontal base plate having an aperture configured to accommodate the stem of the trailer hitch ball;
(2) a substantially vertical back plate, fixedly attached to the base plate, having outwardly flared sides, the back plate disposed substantially between the vehicle and the trailer hitch ball; and
(3) a drop bar notch, extending through both the base plate and the back plate, and configured to receive at least a portion of the elbow of the drop bar.

12. The device according to claim 11, wherein the drop bar notch includes an aperture extending through the back plate and the base plate.

13. The device according to claim 11, wherein the drop bar notch includes vertical sides configured to align with opposing sides of the drop bar.

14. The device according to claim 11, wherein the drop hitch has a drop of more than 2 inches.

15. The device according to claim 11, wherein the stem of the trailer hitch ball extends through the aperture and is bolted to the drop bar, thereby coupling the trailer hitch alignment device to the drop bar.

16. The device according to claim 11, wherein the aperture to accommodate the stem of the trailer hitch ball includes an elongated slot, whereby the position of the device upon the drop bar may be adjusted.

17. The device according to claim 11, wherein the outwardly flared sides of the back plate are flared at an angle of from about 20° to about 80° relative to a centerline of the drop bar.

18. The device according to claim 17, wherein the outwardly flared sides of the back plate are flared at an angle of about 50°.

19. The device according to claim 11, wherein the device is fabricated of materials selected from the group consisting of welded metal plates, stamped or pressed sheet metal, plastic, and fiberglass.

20. A trailer hitch alignment device configured to be bolted to a drop bar of a drop hitch having a drop of more than 2 inches, the drop bar including a substantially horizontal portion, an upwardly extending portion, a curved elbow interconnecting the upwardly extending portion and the substantially horizontal portion, and having opposing sides, the device comprising:
a substantially horizontal base plate having an aperture configured to accommodate a stem of a trailer hitch ball;
a substantially vertical back plate, fixedly attached to a base plate, having outwardly flared sides and a curved apex therebetween, and being configured to partially surround the trailer hitch ball in order to guide a trailer tongue into alignment with the trailer hitch ball; and
a drop bar notch, formed in both the base plate and the back plate in a region of the apex, and configured to receive at least a portion of the curved elbow of a drop bar, the drop bar notch having vertical sides configured to align with opposing sides of the drop bar.
